(19) United States
(12) Patent Application Publication
(10) Pub. No.: US 2026/0109253 A1
(43) Pub. Date: Apr. 23, 2026

(54) ELECTRIC VEHICLE SUPPLY EQUIPMENT AND ENERGY MANAGEMENT SYSTEM

(71) Applicant: Enphase Energy, Inc., Petaluma, CA (US)

(72) Inventors: Shatruddha Singh KUSHWAHA, San Jose, CA (US); Vikas GAHLAN, Cupertino, CA (US); Deva Kalyana Vigneswaran PITCHUMANI, Bangalore (IN); Sivakumar LAGUDUWA SANKARAN, Bangalore (IN); Vinay SRIDHARA MURTHY, Bangalore (IN)

(21) Appl. No.: 19/357,986

(22) Filed: Oct. 14, 2025

(30) Foreign Application Priority Data
Oct. 18, 2024 (IN) 202411079347

(51) Int. Cl. B60L 53/62; B60L 53/51; H02J 3/00; H02J 3/38

(52) U.S. Cl. CPC B60L 53/62; B60L 53/51; H02J 3/0075; H02J 3/38; H02J 2101/24

(57) ABSTRACT

A dynamic single-phase to three-phase switching apparatus is provided and comprises a main panel configured to connect to at least one of a load or photovoltaic systems (PVS), an energy management system (EMS) connected to the main panel and configured to measure real-time data from an electric vehicle supply equipment (EVSE) and a photovoltaic (PV) each connected to the EMS, and a dynamic switching unit configured to connect to the EMS and the electric vehicle supply equipment (EVSE), which connects to an electric vehicle (EV), and comprising a plurality of switching circuits configured to switch between single-phase operation and three-phase operation for charging the EV.

### CROSS-REFERENCE TO RELATED APPLICATIONS

The present application claims the benefit of and priority to Indian Provisional Application Serial No. 202411079347, filed on Oct. 18, 2024, the entire contents of which is incorporated herein by reference.

### BACKGROUND

### Field of the Disclosure

Embodiments of the present disclosure relate generally to methods and apparatus configured for use with electrical vehicle supply equipment (EVSE) and energy management systems.

### Description of the Related Art

EVs are a mobile distributed energy resource, e.g., mobile storage. The EVs can be charged from an electrical grid, from private energy sources (e.g., photovoltaics (PV), and energy storage systems (stationary), or from a public energy source (e.g., Public EVSE). In some instances, it may prove advantageous to be able to switch from single-phase operation to three-phase operation for optimized EV charging. For example, based on available power (e.g., surplus solar or balance of power on different phases) provided by an energy management system (EMS), it may prove advantageous for the EMS to calculate the optimal charging current for the EV and a desired charging speed.

Thus, the inventors describe herein improved electrical vehicle supply equipment (EVSE) and energy management systems.

### SUMMARY

In accordance with aspects of the present disclosure there is provided a dynamic single-phase to three-phase switching apparatus comprising a main panel configured to connect to at least one of a load or photovoltaic systems (PVS). An energy management system (EMS) can be connected to the main panel and configured to measure real-time data from an electric vehicle supply equipment (EVSE) and a photovoltaic (PV) each connected to the EMS. A dynamic switching unit can be configured to connect to the EMS and the electric vehicle supply equipment (EVSE), which connects to an electric vehicle (EV), and comprising a plurality of switching circuits configured to switch between single-phase operation and three-phase operation for charging the EV.

In accordance with aspects of the present disclosure there is provided an electric vehicle supply equipment (EVSE) configured as an energy management system (EMS) or to connect to an EMS. The EVSE can comprise an electric vehicle (EV) side comprising an EV power disconnect circuit configured to connect to an EV and a grid side comprising a grid power disconnect circuit configured to a grid. A photovoltaic (PV) port can be configured to connect to a PV. An EVSE control system can be configured to control the EV power disconnect circuit and the grid power disconnect circuit for charging the EV from at least one of the photovoltaic (PV) and grid, respectively, and for exporting surplus power from the PV to the grid.

These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 is a block diagram of an energy management system, in accordance with one or more embodiments of the present disclosure;

FIG. 2 is a diagram of an EVSE system that is configured to connect to the energy management system of FIG. 1, in accordance with one or more embodiments of the present disclosure;

FIG. 3 is a diagram of a dynamic single-phase to three-phase switching apparatus, in accordance with one or more embodiments of the present disclosure;

FIG. 4 is a diagram of an EVSE with a photovoltaic (PV) port, in accordance with one or more embodiments of the present disclosure; and

FIGS. 5A-5F illustrate diagrams of various use cases of the EVSE with the photovoltaic (PV) port of FIG. 4, in accordance with one or more embodiments of the present disclosure;

FIG. 6 is a diagram of an EVSE with a photovoltaic (PV) port, in accordance with one or more embodiments of the present disclosure; and

FIG. 7 is a diagram of an EVSE with a logically controlled current leakage circuit, in accordance with one or more embodiments of the present disclosure.

### DETAILED DESCRIPTION

Embodiments of the present disclosure provide improved electrical vehicle supply equipment (EVSE) and energy management systems. For example, in at least some embodiments, a dynamic single-phase to three-phase switching apparatus comprising a main panel can be configured to connect to at least one of a load or photovoltaic systems (PVS). An energy management system (EMS) can be connected to the main panel and configured to measure real-time data from an electric vehicle supply equipment (EVSE) and a photovoltaic (PV) each connected to the EMS. A dynamic switching unit can be configured to connect to the EMS or the electric vehicle supply equipment (EVSE) or both, which connects to an electric vehicle (EV), and can comprise a plurality of switching circuits configured to switch between single-phase operation and three-phase operation for charging the EV. In at least some embodiments, an electric vehicle supply equipment (EVSE) can be configured as an energy management system (EMS) or to connect to an EMS. In at least some embodiments, the EVSE can comprise an electric vehicle (EV) side comprising an EV power disconnect circuit configured to connect to an EV and a grid side comprising a grid power disconnect circuit configured to a grid. A photovoltaic (PV) port can be configured to connect to a PV. An EVSE control system can be configured to control the EV power disconnect circuit and the grid power disconnect circuit for charging the EV from at least one of the photovoltaic (PV) or grid or both, and for exporting surplus power from the PV to the grid. In some of the embodiments, the PV port can extend to become an interconnection port and can connect batteries or critical home loads or PV or a combination of different DERs and loads.

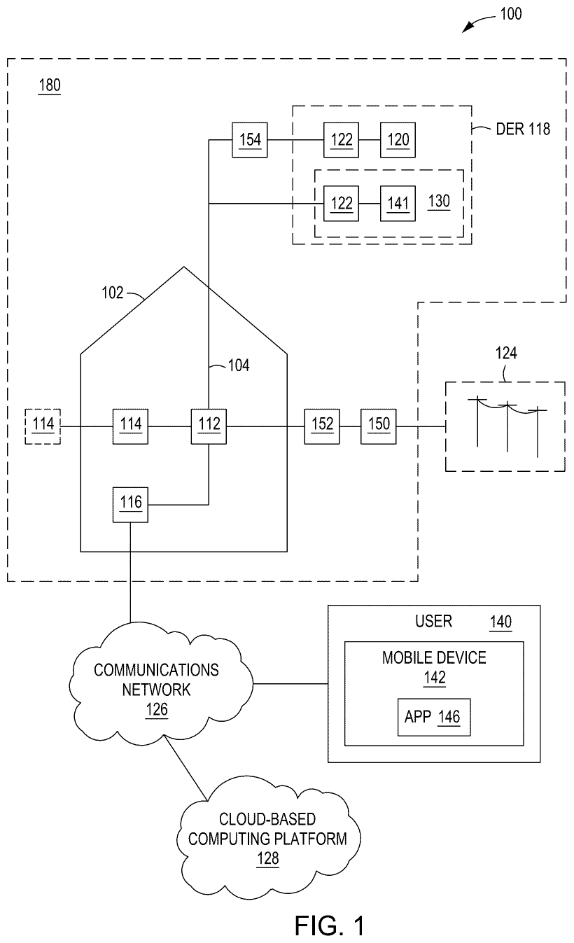

FIG. 1 is a block diagram of an energy management system (e.g., power conversion system, system 100) in accordance with one or more embodiments of the present disclosure. The diagram of FIG. 1 only portrays one variation of the myriad of possible system configurations. The present disclosure can function in a variety of environments and systems.

The system 100 comprises a structure 102 (e.g., a user's structure), such as a residential home, commercial building, or separate mounting structure, having an associated DER 118 (distributed energy resource). The DER 118 can be situated external or internal to the structure 102. For example, the DER 118 as solar power may be located on the roof of the structure 102 or can be part of a solar farm or the DER 118 as a battery can be situated inside the residential home. The structure 102 comprises one or more loads 114 and/or energy storage devices (e.g., appliances, electric hot water heaters, thermostats/detectors, boilers, electric vehicle supply equipment (EVSE), water pumps, and the like), which can be located within or outside the structure 102, and a DER controller 116, each coupled to a load center 112 (e.g., a main panel). Although the one or more loads 114, the DER controller 116, and the load center 112 are depicted as being located within the structure 102, one or more of these may be located external to the structure 102.

The load center 112 is coupled to the DER 118 by an AC bus 104 and is further coupled, via a meter 152 and optionally a MID 150 (microgrid interconnect device), to a grid 124 (e.g., a commercial/utility power grid). The structure 102, the one or more loads 114, DER controller 116, DER 118, load center 112, generation meter 154, the meter 152, and the MID 150 are part of a microgrid 180 (e.g., when the system 100 is not connected to the grid 124). It should be noted that one or more additional devices not shown in FIG. 1 may be part of the microgrid 180. For example, a power meter or similar device may be coupled to the load center 112.

The DER 118 comprises at least one renewable energy source (RES) coupled to power conditioners 122. For example, the DER 118 may comprise a plurality of RESs 120 coupled to a plurality of power conditioners 122 in a one-to-one correspondence (or two-to-one or many-to-one or one-to-many or any other configuration). In embodiments described herein, each RES of the plurality of RESs 120 is a photovoltaic module (PV module), although in other embodiments the plurality of RESs 120 may be any type of system for generating DC power from a renewable form of energy, such as wind, hydro, and the like. The DER 118 may further comprise one or more batteries (or other types of energy storage/delivery devices) coupled to the power conditioners 122 in a one-to-one (or two-to-one or many-to-one or one-to-many or any other configuration) correspondence, where each pair of power conditioner 122 and a corresponding battery may be referred to as an AC battery.

The power conditioners 122 invert the generated DC power from the plurality of RESs 120 and/or the battery 141 to AC power that is grid-compliant and couple the generated AC power to the grid 124 via the load center 112. The generated AC power may be additionally or alternatively coupled via the load center 112 to the one or more loads (e.g., EV, EVSE) and/or the one or more loads 114. In addition, the power conditioners 122 that are coupled to the batteries 141 convert AC power from the AC bus 104 to DC power for charging the batteries 141. A generation meter 154 is coupled at the output of the power conditioners 122 that are coupled to the plurality of RESs 120 in order to measure generated power.

In at least some embodiments, the power conditioners 122 may be AC-AC converters that receive AC input and convert one type of AC power to another type of AC power. Alternatively, the power conditioners 122 may be DC-DC converters that convert one type of DC power to another type of DC power. The DC-DC converters may be coupled to a main DC-AC inverter for inverting the generated DC output to an AC output. Any AC to DC device which is configured to convert AC generated from renewable sources to DC can be used for charging an EV, e.g., a bi-directional inverter such as a simple charger onboard an EV. A key aspect of the present disclosure is the ability of measuring the energy (AC or DC) supplied to an EV battery.

The power conditioners 122 may communicate with one another and with the DER controller 116 using power line communication (PLC), although additionally and/or alternatively other types of wired and/or wireless communication may be used. The DER controller 116 may provide operative control of the DER 118 and/or receive data or information from the DER 118. For example, the DER controller 116 may be a gateway or combiner or a Bidirectional EVSE (which includes a gateway and consolidates interconnection equipment into a single enclosure and streamlines PV and storage installations by providing a consistent, pre-wired solution for residential applications) that receives data (e.g., alarms, messages, operating data, performance data, and the like) from the power conditioners 122 and communicates the data and/or other information via the communications network 126 to a cloud-based computing platform 128, which can be configured to execute one or more application software, e.g., a grid connectivity control application, to a mobile app, to a remote device or system such as a master controller (not shown), and the like. The DER controller 116 may also send control signals to the power conditioners 122, such as control signals generated by the DER controller 116 or received from a remote device or the cloud-based computing platform 128. The DER controller 116 may be communicably coupled to the communications network 126 via wired and/or wireless techniques. For example, the DER controller 116 may be wirelessly coupled to the communications network 126 via a commercially available router. In one or more embodiments, the DER controller 116 comprises an application-specific integrated circuit (ASIC) or microprocessor along with suitable software (e.g., a grid connectivity control application) for performing one or more of the functions described herein. For example, the DER controller 116 can include a memory (e.g., a non-transitory computer readable storage medium) having stored thereon instructions that when executed by a processor perform a method that provides the EVSE with a capability to directly (e.g., using current measurement inputs) or indirectly (e.g., using communication protocols to a remote measurement device) measure a net current being imported from or exported to a grid. Thereafter, the EVSE can use one or more control systems (e.g., an integral power control system (PCS)) to increase and/or decrease the charging and/or discharging rate of the EV to prevent overload of a service transformer, or grid interconnection, or any bus bar/feeder/breaker ratings, as described in greater detail below.

The generation meter 154 (which may also be referred to as a production meter) may be any suitable energy meter that measures the energy generated by the DER 118 (e.g., by the power conditioners 122 coupled to the plurality of RESs 120). The generation meter 154 measures real power flow (kW) and, in some embodiments, reactive power flow (kVAR). The generation meter 154 may communicate the measured values to the DER controller 116, for example using PLC, other types of wired communications, or wireless communication. Additionally, battery charge/discharge values are received through other networking protocols from the AC battery 130 itself. The generation meter 154 can be internal or external to the DER controller 116.

The meter 152 may be any suitable energy meter that measures the energy consumed/imported by the system 100, such as a net-metering meter, a bi-directional meter that measures energy imported from the grid 124 and as well as energy exported to the grid 124, a dual meter comprising two separate meters for measuring energy ingress and egress, and the like. In some embodiments, the meter 152 comprises the MID 150 or a portion thereof. The meter 152 measures one or more of real power flow (kW), reactive power flow (kVAR), grid frequency, and grid voltage. The meter 152 measures power flows independently of MID state, i.e., when MID is closed and DER's are connected to the grid and when MID is open and DER's are isolated from the grid. The meter 152 can be internal or external to the DER controller 116.

The MID 150, which may also be referred to as an island interconnect device (IID), connects/disconnects the system 100 to/from the grid 124. That is, when the system 100 is disconnected from the grid 124, the system 100 becomes a microgrid. The MID 150 comprises a disconnect component (e.g., a contactor or the like) for physically connecting/disconnecting the microgrid 180 to/from the grid 124. For example, the DER controller 116 receives information regarding the present state of the system from the power conditioners 122, and also receives the energy consumption values of the microgrid 180 from the meter 152 (for example via one or more of PLC, other types of wired communication, and wireless communication), and based on the received information (inputs), the DER controller 116 determines when to go on-grid or off-grid and instructs the MID 150 accordingly. In some alternative embodiments, the MID 150 comprises an ASIC or CPU, along with suitable software (e.g., an islanding module) for determining when to disconnect from/connect to the grid 124. For example, the MID 150 may monitor the grid 124 and detect a grid fluctuation, disturbance or outage and, as a result, disconnect the microgrid 180 from the grid 124. Once disconnected from the grid 124, the microgrid 180 can continue to generate power as an intentional island without imposing safety risks, for example on any line workers that may be working on the grid 124. The MID 150 can be internal or external to the DER controller 116.

In some alternative embodiments, the MID 150 or a portion of the MID 150 is part of the DER controller 116. For example, the DER controller 116 may comprise a CPU and an islanding module for monitoring the grid 124, detecting grid failures and disturbances, determining when to disconnect from/connect to the grid 124, and driving a disconnect component accordingly, where the disconnect component may be part of the DER controller 116 or, alternatively, separate from the DER controller 116. In some embodiments, the MID 150 may communicate with the DER controller 116 (e.g., using wired techniques such as power line communications, or using wireless communication) for coordinating connection/disconnection to the grid 124.

A user 140 can use one or more computing devices, such as a mobile device 142 (e.g., a smart phone, tablet, laptop or the like) communicably coupled by wireless/wired means to the communications network 126. The mobile device 142 has a CPU, support circuits, and memory, and has one or more applications (e.g., a grid connectivity control application (an application 146)) installed thereon for controlling the connectivity with the grid 124 as described herein. The may run on commercially available operating systems, such as IOS, ANDROID, WINDOWS and the like.

In order to control connectivity with the grid 124, the user 140 interacts with an icon displayed on the mobile device 142, for example a grid on-off toggle control or slide, which is referred to herein as a toggle button. The toggle button may be presented on one or more status screens pertaining to the microgrid 180, such as a live status screen (not shown), for various validations, checks and alerts. The first time the user 140 interacts with the toggle button, the user 140 is taken to a consent page, such as a grid connectivity consent page, under setting and will be allowed to interact with toggle button only after he/she gives consent.

Once consent is received, the scenarios below, listed in order of priority, will be handled differently. Based on the desired action as entered by the user 140, the corresponding instructions are communicated to the DER controller 116 via the communications network 126 using any suitable protocol, such as HTTP(S), MQTT(S), WebSockets, and the like. The DER controller 116, which may store the received instructions as needed, instructs the MID 150 to connect to or disconnect from the grid 124 as appropriate.

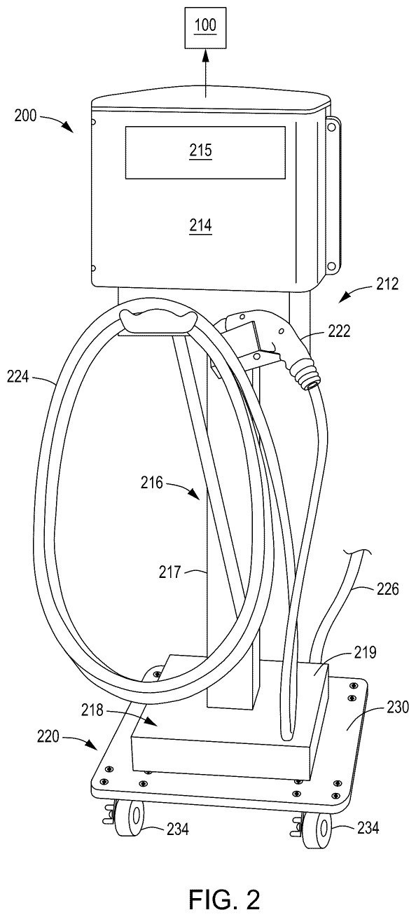

FIG. 2 is a diagram of an EVSE system (a system 200), in accordance with one or more embodiments of the present disclosure. As shown in FIG. 2, the system 200 is configured to connect to the system 100 and comprises electric vehicle supply equipment 212, a housing enclosure 214, a pedestal 216 having a base 218, and a transport module 220 coupled to the base 218. The electric vehicle supply equipment 212 can include an electric vehicle connector 222, which can comprise a cord 224, configured for connection to an electric vehicle inlet (not shown). The electric vehicle supply equipment 212 can include a service entrance cable 226 configured to connect, for example, to the load center 112 wiring to deliver energy to the electric vehicle connector 222. The electric vehicle supply equipment 212 can include a controller 215 (e.g., similar to the DER controller 116) which can be housed in the housing enclosure 214. The electric vehicle supply equipment 212 can also include ungrounded, grounded, and equipment grounding conductors, attachment plugs, and other fittings, devices, power outlets, or apparatuses necessary to deliver energy from the premises wiring (not shown) to an EV (not shown), all or a portion of which may be enclosed within housing enclosure 214. The pedestal 216 is coupled to and supports the housing enclosure 214 and may include a hollow tubular portion 217 and a base 218. The base 218 may include a base cover 219 and a base plate (not shown) configured to engage and be supported on a top surface of the transport module 220. The transport module 220 comprises a platform 230 that is configured to support the base 218, and wheels 234 are provided on the platform 230 to facilitate moving the system 200 when not connected to the system 100. In addition, system 200 can have additional connection points to connect different DERs and Loads (similar to DER controller 116).

The electric vehicle supply equipment 212 (including electric vehicle connector 222, cord 224, and service entrance cable 226), the housing enclosure 214, and the pedestal 216 (including hollow tubular portion 217 and base 218), may be a commercially available electric vehicle charge station such as, for example but not limited to, a CS Series Public EVSE provided by ClipperCreek, Inc. of Auburn, Calif.

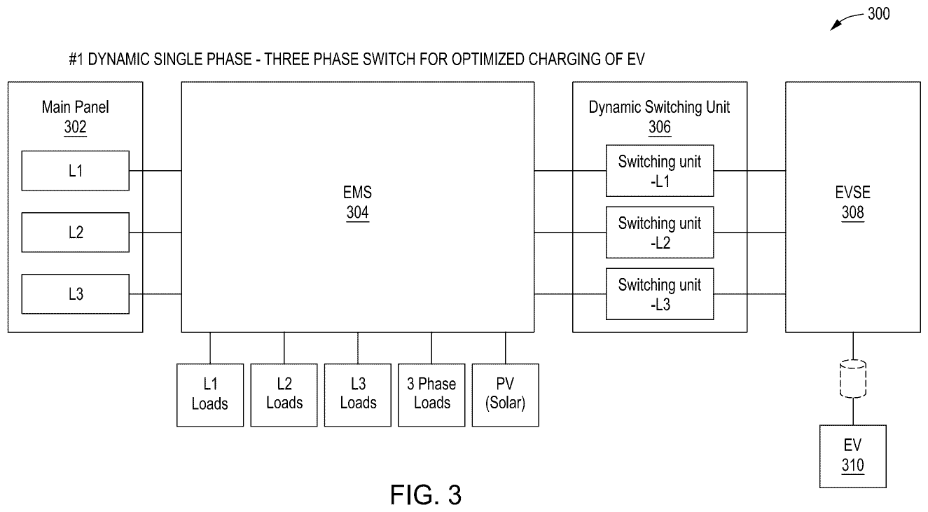

As described above, inventive concepts described herein provide improved EVSE and energy management systems. For example, FIG. 3 is a diagram of a dynamic single-phase to three-phase switching apparatus 300, in accordance with one or more embodiments of the present disclosure.

As noted above, the dynamic single-phase to three-phase switching apparatus 300 continuously monitors real-time solar generation and EV charging power. For example, when surplus power exists, the dynamic single-phase to three-phase switching apparatus 300 is configured to calculate an optimal charging current for the EV 310 based on available power (e.g., surplus solar or balance of power on different phases) and a desired charging speed. Accordingly, the dynamic single-phase to three-phase switching apparatus 300 is configured to adjust a charging current in real-time based on changes in surplus power and ensures that the total building/home power consumption remains within limits (e.g., if using a smart meter), as described in greater detail below.

Continuing with reference to FIG. 3, the dynamic single-phase to three-phase switching apparatus 300 comprises a main panel 302, an EMS 304, a dynamic switching unit 306, and an EVSE 308. The main panel 302 (e.g., the load center 112), which can be part of the EMS (e.g., the system 100), can comprise one or more power lines configured for single-phase and/or three-phase operation. For example in at least some embodiments, the AC bus 104 comprises a first line (L1), a second line (L2), and a third line (L3) that connect to the one or more loads 114 (single-phase loads, three-phase loads, photovoltaic systems (PVS), e.g., PV panel and DER controller). The EMS 304 connects to the dynamic switching unit 306 which comprises one or more switches (e.g., electromechanical or electronic switches that are configured to open/close circuits). For example, the one or more switches can comprise a first switch (S1), a second switch (S2), and a third switch (S3). The first switch (S1) connects to the first line (L1), the second switch (S2) connects to the second line (L1), and the third switch (S3) connects to the third line (L3). Each of the first switch (S1), the second switch (S2), and the third switch (S3) connects to the EVSE 308 (the system 200, e.g., a charging station), which is configured to connect to one or more EVs (one EV is shown). In at least some embodiments, the EMS 304 and/or the dynamic switching unit 306 can be configured to identify and/or recommend the first line (L1), the second line (L2), and the third line (L3) (e.g., at the time of installation/operation) to facilitate maximizing a charge. For example, in at least some embodiments, when the second line (L2) is less loaded than the first line (L1) or the third line (L3), e.g., an imbalanced load, the EMS 304 and/or the dynamic switching unit 306 can be configured to recommend interchanging the first line (L1) or the third line (L3) to the second line (L2), e.g., to use the extra power available on the second line (L2) for a single-phase charging.

In at least some embodiments, the EMS 304 and EVSE 308 can be a single unit or can be separate units from each other. Similarly, the dynamic switching unit 306 can be a component of the EMS 304 or the EVSE 308 or the dynamic switching unit 306 can be a separate component from the EMS 304 or the EVSE 308 and controlled by the EMS 304 or the EVSE 308.

In operation, the EMS 304 acts/functions as the central control unit by monitoring real-time data received from the EVSE 308. In at least some embodiments, the EMS 304 measures power delivered to the EV 310. Additionally, the EMS 304 monitors real-time data received from the DER 118 (e.g., the PVS) and provides information on current and/or projected solar power generation. In at least some embodiments, such as when the meter 152 is a smart meter, the EMS 304 tracks the total structure (e.g., the structure 102) power consumption (e.g., building power consumption).

In operation, the dynamic switching unit 306 is configured to facilitate the automatic transition between single-phase and three-phase charging based on, for example, surplus power availability. For example, one or more solid-state relays, contactors, and/or standard AC relays can be used for physically switching between single-phase and three-phase charging the EV 310 by the EVSE 308. In at least some embodiments, the one or more solid-state relays, contactors, and/or standard AC relays can be part of the EVSE 308 or external to the EVSE.

In operation, the EVSE 308, which is compatible with both single-phase and three-phase operations provides communication protocol integration for enabling communication with the EMS 304 for dynamic power adjustments and provides fine-grained power control for allowing the EMS 304 to adjust charging current in small increments (e.g., 1 amp increments for single-phase or as allowed by standards) for optimal utilization of surplus power.

For example, when surplus solar power is available, it may prove advantageous to charge the EV from the PVS (e.g., solar) only. In some embodiments, such as when the PVS are connected only to a single phase, the EMS 304 can be configured to charge the EV 310 with PVS (e.g., solar). In doing so, the EMS 304 needs to draw current from line (L2) and line (L3). For example, at 230V, if charging through PVS at 6 amps, 1.38 kW would be drawn, but since power has to be drawn from the second line (L2) and the third line (L3) as well, 2.76 kW would also be drawn from the grid 124, i.e., because of three phase operation, a balanced power will be drawn from all three phases. Thus, by switching to single-phase, the EV 310 would be charged only from solar.

Additionally, in some embodiments, the EMS 304 can be configured to accommodate different loading conditions on different phases. For example, when the main panel 302 is rated at 64A a maximum of 64A can be drawn on each of the first line (L1), the second line (L2), and the third line (L3). In an imbalanced load, e.g., 64A on the third line (L3), 50A on the second line (L2), and 32A on the first line (L1), the EV 310 cannot be charged with three-phase (i.e., since the third line (L3) reached the current limit of 64A). Accordingly, the EMS 304 can be configured to switch from three-phase to single-phase charging the EV 310 using the second line (L2) at 14A or the first line (L1) at 32A.

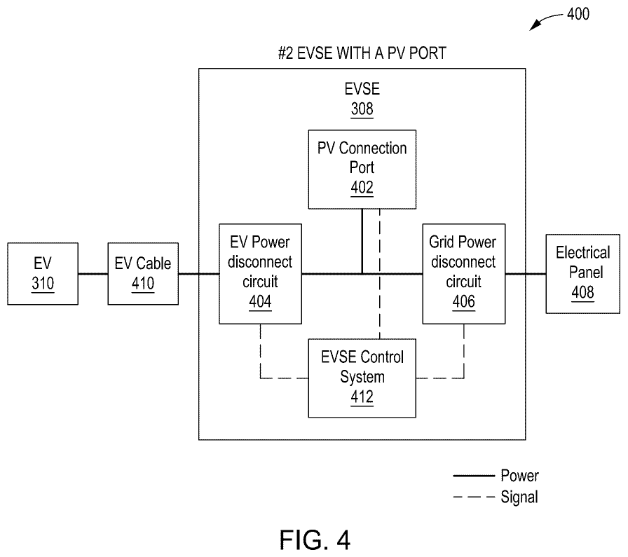

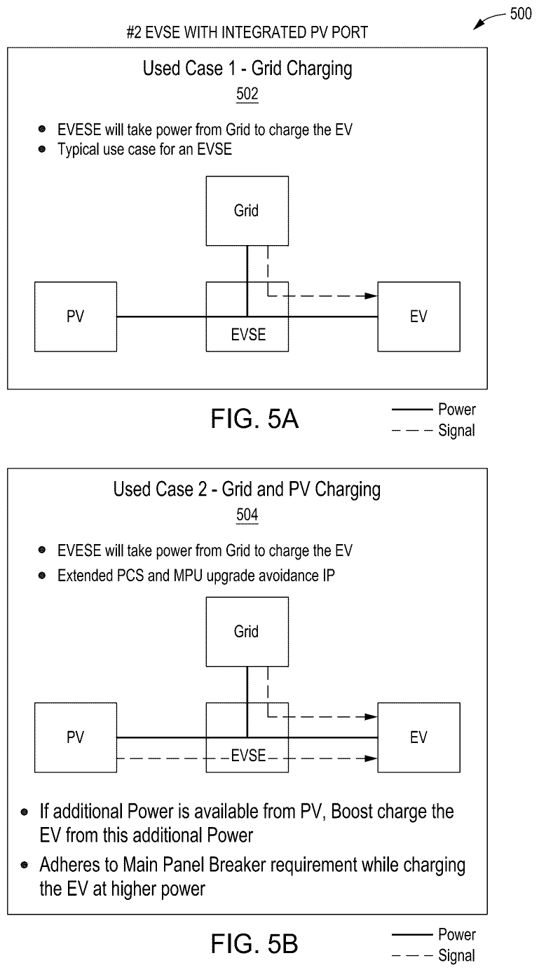

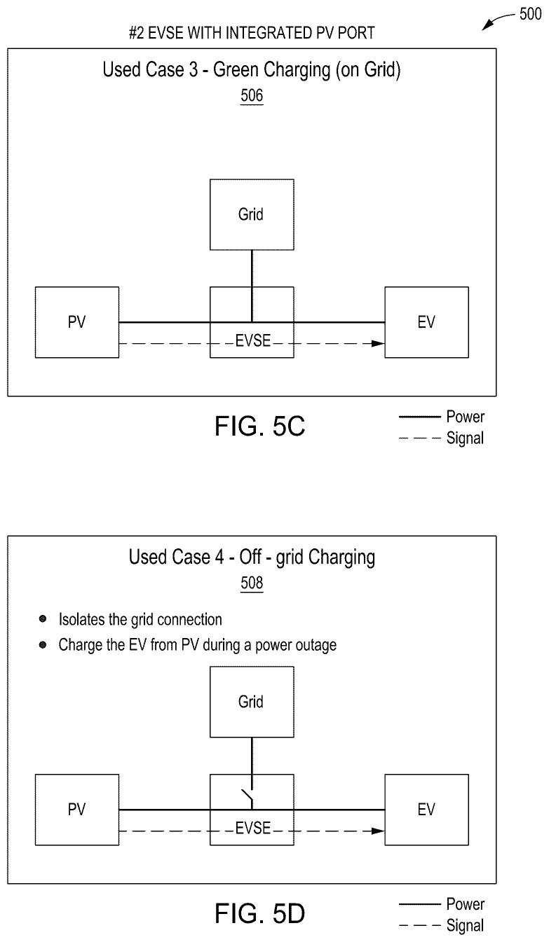

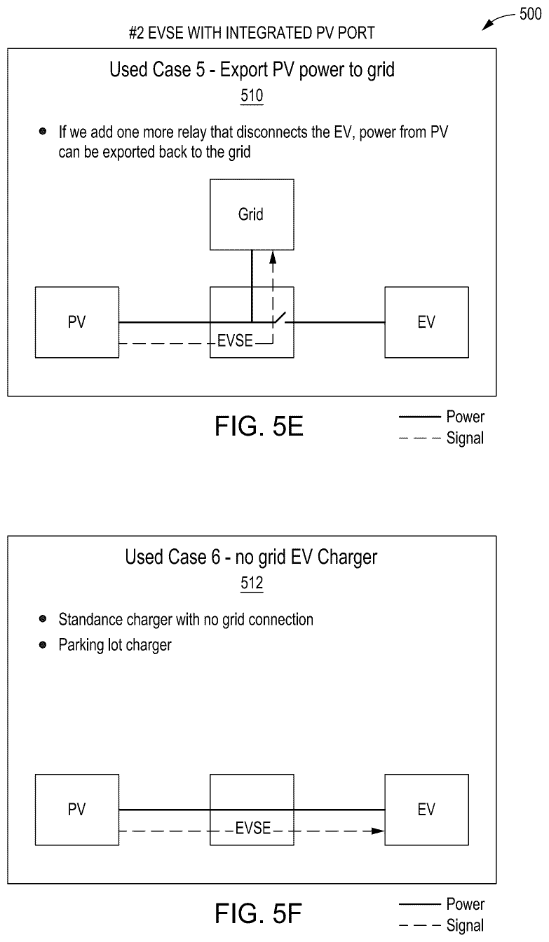

FIG. 4 is a diagram 400 of the EVSE 308 with a photovoltaic (PV) port, and FIGS. 5A-5F are diagrams 500 of various use cases of the EVSE 308 with the photovoltaic (PV) port of FIG. 4, in accordance with one or more embodiments of the present disclosure. For example, the EVSE 308 can comprise a PV Port 402. In at least some embodiments, the PV Port 402 can be a terminal (not shown) that is configured to connect one or more PV wires or a sub panel where multiple PVS are combined together. The EVSE 308 can comprise one or more power disconnect circuits. In at least some embodiments, the EVSE 308 can comprise an EV power disconnect circuit 404 and/or a grid power disconnect circuit 406. For example, in at least some embodiments, the EV power disconnect circuit 404 can be on the EV side and can connect to the EV 310 via an EV cable 410 (e.g., the cord 224) and the grid power disconnect circuit 406 can be on the grid side and can connect to the grid 124 via an electric panel 408 (e.g., the load center 112). Alternatively or additionally, the EVSE 308 can comprise one or more power disconnect circuits on the grid side (e.g., the grid power disconnect circuit 406) and a second power disconnect circuit on a PV side (not shown). By providing the PV Port 402 on the EVSE 308, a Home Owner (HO) can add PVS in a relatively simple manner (e.g., no additional equipment required). In a three phase system, PVS can be connected to any one phase or all three phases. In a case of connection to a single phase, the EVSE 308 can be configured for dynamic phase switching as described above.

An EVSE control system 412 is configured to control operation of the EV power disconnect circuit 404 and the grid power disconnect circuit 406, e.g., for controlling operation of the various use cases of FIGS. 5A-5F. For example, by providing the PV Port 402 on the EVSE 308, the following use cases for the EVSE 308 can be achieved. In at least some embodiments, the EV can be charged from at least one of the grid (see 502 of FIG. 5A) or a PV together (see 504 of FIG. 5B), which can reduce import of grid power, can reduce installation costs, can allow a Home Owner (HO) to purchase an EV and subsequently purchase one or more PVS, and can allow a HO to do more power charging while adhering to main panel upgrade avoidance and PCS (e.g., if only available breaker capacity in the electrical panel is 20 A, the EV can still charge at higher than 20 A, e.g., 32 A if 12A is available from PV.

Additionally, by providing the PV Port 402 on the EVSE 308, a HO can perform on grid green charging and off grid charging (see 506 and 508 of FIG. 5C and FIG. 5D, respectively). In the latter instance, for example, a HO can charge the EV 310 even during a power outage, e.g., as long as solar power is available, and a HO does not need complex installation requirements of additional MID switches, as the EVSE 308 is capable of grid isolation.

Moreover, by providing the PV Port 402 on the EVSE 308, a HO can export PV power (see 510 of FIG. 5E) to the grid (e.g., when not charging the EV 310), can export surplus PV power back to grid, which is agnostic of the presence of the EV 310, e.g., the EVSE 308 acts as a PV control and metering block.

Furthermore, by providing the PV Port 402 on the EVSE 308, a HO (or user of a public charging space) does not to rely on grid charging (see 512 of FIG. 5F), as the EVSE 308 can operate as standalone unit and does not need a grid connection, e.g., can charge the EV 310 from solar. The EVSE 308 can be installed in parking locations, remote locations, etc., and does not need large infrastructure cost to bring grid connection to a charger site.

By providing the PV Port 402 on the EVSE 308, a HO is provided with a seamless transition from off grid to on grid/on grid to off grid when solar power is present (see 512 of FIG. 5F).

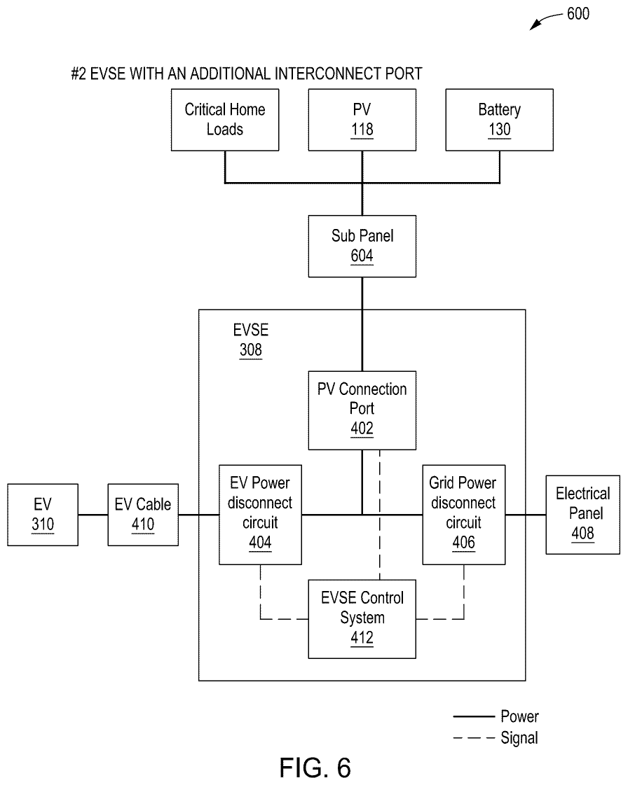

FIG. 6 is a diagram 600 of an EVSE 308 with an interconnection port, in accordance with one or more embodiments of the present disclosure. For example, unlike EVSE 308 of FIG. 4, which comprises the PV Port 402, the EVSE 308 of FIG. 6 comprises an interconnection port 602. The interconnection port 602 is configured to connect to one or more PVS (e.g., the RES of the DER 118), batteries (e.g., the AC battery 130) and/or critical loads (e.g., the one or more loads 114), e.g., via a sub panel 604. The EVSE 308 comprises the EV power disconnect circuit 404 and/or the grid power disconnect circuit 406, as described above. Alternatively, one of the EV power disconnect circuit 404 or the grid power can be on the interconnection port 602 side.

By providing the interconnection port 602, the addition of the PVS, batteries and managing of power to critical loads is made relatively easy for a HO, e.g., no additional equipment is required for islanding and HEMS control, as the EVSE 308 can be integrated HEMS.

The interconnection port 602 is configured to allow a HO to charge from the grid, PVS and/or battery or a combination of these DERs at the same time, which can reduce import of grid power, and the interconnection port 602 can be installed at relatively low cost. Additionally, by providing the interconnection port 602, a HO can purchase an EV, and subsequently, purchase one or more PVS. The interconnection port 602 can provide a HO with more power charging, while adhering to main panel upgrade avoidance and PCS, e.g., when only available breaker capacity in the electrical panel is 20 A, EV can still charge at higher than 20 A, e.g., 32 A if 12A is available from PV.

Additionally, by providing the interconnection port 602 on the EVSE 308, a HO can perform on grid green charging and off grid charging. In the latter instance, for example, a HO can charge the EV 310 even during a power outage, e.g., as long as solar power is available, and a HO does not need complex installation requirements of additional MID switches, as the EVSE 308 is capable of grid isolation.

Moreover, by providing the interconnection port 602 on the EVSE 308, a HO can export PV power to the grid (e.g., when not charging the EV 310), can export surplus PV power back to grid, which is agnostic of the presence of the EV 310, e.g., the EVSE 308 acts as a PV control and metering block.

Furthermore, by providing the interconnection port 602 on the EVSE 308, a HO does not to rely on grid charging, as the EVSE 308 can operate as standalone unit and does not need a grid connection, e.g., can charge the EV 310 from solar. The EVSE 308 can be installed in parking locations, remote locations, etc., and does not need large infrastructure cost to bring grid connection to a charger site.

By providing the interconnection port 602 on the EVSE 308, a HO is provided with a seamless transition from off grid to on grid/on grid to off grid when solar power is present.

By providing the interconnection port 602 on the EVSE 308, automated islanding can be achieved, and a net-zero functionality (e.g., close to zero import/export to the grid) can be maintained by generating, storing and utilizing the energy within the home environment (e.g., in a savings mode).

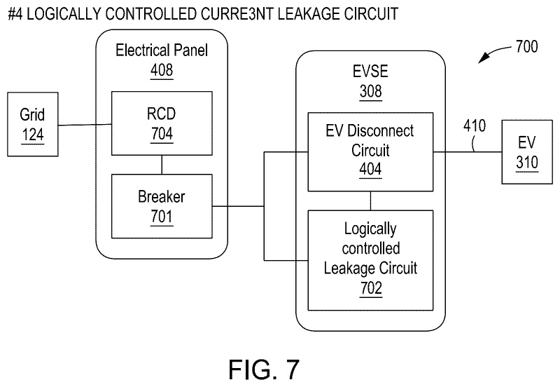

FIG. 7 is a diagram 700 of an EVSE 308 with a logically controlled current leakage circuit, in accordance with one or more embodiments of the present disclosure. For example, residual current devices (RCDs) are configured to protect against electrocution and fires, which can be caused by earth faults. For example, the RCDs can be configured to monitor the flow of electricity through a circuit and can quickly switch off the circuit if the RCDs detect electricity flowing through an unintended path. The RCDs are, typically, installed before an overcurrent protection device (e.g., a breaker 701) towards a grid (e.g., the grid 124).

In at least some embodiments, the EVSE 308 can comprise a logically controlled leakage circuit 702, which is configured to leak electrical current into an unintended path and trigger an upstream RCD 704 to trip. For example, during operation, if any of the relays become welded (e.g., contacts melt and/or are stuck together), AC will be directly available at the EV cable 410 outlet, which can cause a safety event/issue. Accordingly, the EVSE 308 is configured to detect if any of the relays are welded closed, and if the relays are found closed, the logically controlled leakage circuit 702 is triggered to intentionally trip the RCD 704 and implement electrical safety. For example, the EVSE 308 can be configured to detect relay welding by measuring a voltage after the relay, and the physical integrity of the relay can be determined based on the measured voltage. Additionally or alternatively, the EVSE 308 can be configured to detect welded contactors by commanding the contactors to open at the end of a drive cycle, and, if the contactor fails to open, the relay may be considered welded. Additionally, in at least some embodiments, the EVSE 308 can also be configured to send a notification message (e.g., to the homeowner/user/operator/maintainer) of the event and cause of the trip.

In at least some embodiments, at the time of installation, as part of the commissioning flow, the logically controlled leakage circuit 702 can be triggered as part of an automated functional validation to check if RCDs are installed, which can ensure that correct safety installations are in place.

In at least some embodiments, the EVSE 308 (BIDI) and the meter 152 (e.g., the meter collar) can function as a power conversion system (PCS). In doing so, the PCS can perform current limiting for a microprocessing unit (MPU), e.g., the DER controller 116. Additionally, the PCS can be configured to power draw from a split phase configuration to stay within operating limits of interconnection while maximizing for EV power. For example, for a home with a 100A interconnection (i.e., 80A available), the first line (L1) can be loaded to about 60A, the second line (L2) can be loaded to about 40A, which, typically, would allow about 20A available to charge an EV, e.g., 80A-60A available between the first line (L1) and the second line (L2), i.e., 4.8 kW. Thus, when using the EVSE 308 (BIDI), the EVSE 308 (BIDI) can be configured to provide about 20A between the first line (L1) and the second line (L2) and additionally 20A between the second line (L2) and Neutral, i.e., an additional 20×120=2.4 kw a total of 4.8+2.4=7.2 kw (50% more).

While the foregoing is directed to embodiments of the present disclosure, other and further embodiments of the disclosure may be devised without departing from the basic scope thereof, and the scope thereof is determined by the claims that follow.

What is claimed IS:

1. A dynamic single-phase to three-phase switching apparatus comprising:
a main panel configured to connect to at least one of a load or photovoltaic systems (PVS);
an energy management system (EMS) connected to the main panel and configured to measure real-time data from an electric vehicle supply equipment (EVSE) and a photovoltaic (PV) each connected to the EMS; and
a dynamic switching unit configured to connect to the EMS and the electric vehicle supply equipment (EVSE), which connects to an electric vehicle (EV), and comprising a plurality of switching circuits configured to switch between single-phase operation and three-phase operation for charging the EV.

2. The dynamic single-phase to three-phase switching apparatus of claim 1, wherein the main panel comprises a first line (L1), a second line (L2), and a third line (L3) that are configured to connect to at least one of single-phase loads, three-phase loads, PV panels, or DER controller.

3. The dynamic single-phase to three-phase switching apparatus of claim 2, wherein the plurality of switching circuits comprise a first switch (S1) that connects to the first line (L1), a second switch (S2) that connects to the second line (L1), and a third switch (S3) that connects to the third line (L3).

4. The dynamic single-phase to three-phase switching apparatus of claim 3, wherein each of the first switch (S1), the second switch (S2), and the third switch (S3) connects to the electric vehicle supply equipment (EVSE).

5. The dynamic single-phase to three-phase switching apparatus of claim 3, wherein at least one of the energy management system (EMS) or the dynamic switching unit is further configured to identify and/or recommend the first line (L1), the second line (L2), and the third line (L3) during operation to facilitate maximizing charging of the load.

6. The dynamic single-phase to three-phase switching apparatus of claim 5, wherein the at least one of the energy management system (EMS) or the dynamic switching unit is further configured to interchange the first line (L1), the second line (L2), or the third line (L3) when an imbalanced load is present on one of the first line (L1), the second line (L2) or the third line (L3) to use extra power available on the imbalanced load.

7. The dynamic single-phase to three-phase switching apparatus of claim 1, wherein the real-time data comprises power delivered to the electric vehicle (EV).

8. The dynamic single-phase to three-phase switching apparatus of claim 1, wherein the dynamic switching unit is further configured to facilitate an automatic transition between single-phase and three-phase charging based on surplus power availability.

9. The dynamic single-phase to three-phase switching apparatus of claim 1, wherein the electric vehicle supply equipment (EVSE) is configured to provide communication protocol integration for enabling communication with the energy management system (EMS) for dynamic power adjustments and provide fine-grained power control for allowing the energy management system (EMS) to incrementally adjust a charging current for optimal utilization of surplus power.

10. The dynamic single-phase to three-phase switching apparatus of claim 9, wherein the charging current is adjusted at 1 amp increments for single-phase.

11. The dynamic single-phase to three-phase switching apparatus of claim 1, wherein the energy management system (EMS) is further configured to charge the electric vehicle (EV) from the photovoltaic systems (PVS) when surplus solar power is available.

12. The dynamic single-phase to three-phase switching apparatus of claim 1, wherein the energy management system (EMS) is further configured to accommodate different loading conditions on different phases.

13. An electric vehicle supply equipment (EVSE) configured as an energy management system (EMS) or to connect to an energy management system (EMS), comprising:
an electric vehicle (EV) side comprising an electric vehicle (EV) power disconnect circuit configured to connect to an electric vehicle (EV) and a grid side comprising a grid power disconnect circuit configured to a grid;
a photovoltaic (PV) port configured to connect to a photovoltaic (PV); and
an electric vehicle supply equipment (EVSE) control system configured to control the electric vehicle (EV) power disconnect circuit and the grid power disconnect circuit for charging the electric vehicle (EV) from at least one of the photovoltaic (PV) or grid, respectively, and for exporting surplus power from the photovoltaic (PV) to the grid.

14. The electric vehicle supply equipment (EVSE) of claim 13, wherein the photovoltaic (PV) port is further configured to connect to the photovoltaic (PV) via at least one of photovoltaic (PV) wires or a sub panel where multiple photovoltaic systems (PVS) are combined together.

15. The electric vehicle supply equipment (EVSE) of claim 13, wherein the electric vehicle supply equipment (EVSE) control system is further configured to interchange a first line (L1), a second line (L2), or a third line (L3) of the energy management system (EMS) when an imbalanced load is present on one of the first line (L1), the second line (L2) or the third line (L3) to use extra power available on the imbalanced load.

16. The electric vehicle supply equipment (EVSE) of claim 13, wherein the electrical vehicle (EV) is charged from the grid.

17. The electric vehicle supply equipment (EVSE) of claim 13, wherein the electrical vehicle (EV) is charged from the photovoltaic (PV).

18. The electric vehicle supply equipment (EVSE) of claim 13, wherein the electrical vehicle (EV) is charged from the photovoltaic (PV) and the grid together.

19. The electric vehicle supply equipment (EVSE) of claim 13, wherein the electric vehicle supply equipment (EVSE) control system is further configured to at least one of export PV power to the grid when not charging the electrical vehicle (EV), export surplus photovoltaic (PV) power back to grid, or act as a photovoltaic (PV) control and metering block.

20. The electric vehicle supply equipment (EVSE) of claim 13, further comprising a logically controlled leakage circuit configured to leak electrical current into an unintended path and trigger an upstream residual current device (RCD) to trip.
